(19) United States
(12) Patent Application Publication
(10) Pub. No.: US 2009/0046866 A1
(43) Pub. Date: Feb. 19, 2009

(54) APPARATUS CAPABLE OF PERFORMING ACOUSTIC ECHO CANCELLATION AND A METHOD THEREOF

(75) Inventors: Yu-Chun Feng, Taipei City (TW); Li-Te Wu, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 12/140,333

(22) Filed: Jun. 17, 2008

Related U.S. Application Data
(60) Provisional application No. 60/955,879, filed on Aug. 15, 2007.

(51) Int. Cl. H04B 3/20

(52) U.S. Cl. 381/66

(57) ABSTRACT

An apparatus capable of performing acoustic echo cancellation and a method thereof are provided. The apparatus comprises a mapping matrix, first and second speakers, first and second microphones, a reference generator, and a multi-channel acoustic echo canceller. The mapping matrix generates an output signal according to the first and second far end signals. The first and second speakers, coupled to the mapping matrix, play the output signal. The first and second microphones receive the first and second echo signals that are acoustically coupled from the first and second speakers to the first and second microphones, wherein the first and second echo signals are correlated to the output signal. The reference generator generates a reference signal linearly correlated to the output signal according to the first and second far end signals. The multi-channel acoustic echo canceller, coupled to the reference generator and the first and second microphones, filters the reference signal to generate the first and second filtered signals to be indicative of the estimated echo signals at the first and second microphones, subtracts the first filtered signal from the first echo signal to generate a first error signal, and subtracts the second filtered signal from the second echo signal to generate a second error signal, and then transmits the first and second error signals to a far end terminal.

### CROSS REFERENCE

This application claims the benefit of U.S. provisional application Ser. No. 60/955,879 filed Aug. 15, 2007, the subject matter of which is incorporated herein by reference.

### BACKGROUND OF THE INVENTION

1. Field of the Invention

The invention relates to audio signal processing, and in particular to an apparatus capable of performing acoustic echo cancellation and a method thereof.

2. Description of the Related Art

Duplex audio communications systems, such as speakerphones and video communications systems having audio capabilities, utilize both a microphone and a speaker. The microphone transmits speech and other voice data from the local terminal to remote terminals while the speaker plays the voice data received from the remote terminals. For a typical hands-free system, the speaker and microphone are located in close proximity and sounds produced by the speaker are picked up by the microphone, referred to as echo. Without signal processing, the echo would be heard by the remote user at the far end terminal, causing undesirable “howling” noises and an unpleasant psycho-acoustical experience. An acoustic echo canceller is employed to remove echo captured by microphones, typically in a single audio channel environment.

Meanwhile, with the development of high efficiency speech and image coding techniques, development for audio communication systems with high-volume data capacity has increased. Specifically, much attention has been focused on teleconference systems which allow participants to concurrently communicate with each other. In general, stereo audio data are often used in a teleconference environment, where audio signals in multiple audio channels are exchanged among participating parties in both uploading and downloading directions. Thus, a need exists for an apparatus in a teleconference system to perform multi-channel acoustic echo cancellation and a method thereof

### BRIEF SUMMARY OF THE INVENTION

A detailed description is given in the following embodiments with reference to the accompanying drawings.

According to the invention, an apparatus capable of performing acoustic echo cancellation is disclosed, comprising a mapping matrix, first and second speakers, first and second microphones, a reference generator, and a multi-channel acoustic echo canceller. The mapping matrix generates an output signal according to first and second far end signals. The first and second speakers, coupled to the mapping matrix, play the output signal. The first and second microphones receive first and second echo signals that are acoustically coupled from the first and second speakers to the first and second microphones, wherein the first and second echo signals are correlated to the output signal. The reference generator generates a reference signal linearly correlated to the output signal according to the first and second far end signals. The multi-channel acoustic echo canceller, coupled to the reference generator and the first and second microphones, filters the reference signal to generate first and second filtered signals to be indicative of the estimated echo signals at the first and second microphones. Next, the multi-channel acoustic echo canceller subtracts the first filtered signal from the first echo signal to generate a first error signal, and subtracts the second filtered signal from the second echo signal to generate a second error signal, and then transmits the first and second error signals to a far end terminal.

A method for signal processing at a near end apparatus of a duplex communication system for acoustic echo cancellation is also disclosed, comprising determining whether there is communication between the near end apparatus and a far end apparatus. If there is communication, then a mapping matrix would generate an output signal according to first and second far end signals, the first and second speakers would play the output signal, and the first and second microphones would receive the first and second echo signals that are acoustically coupled from the first and second speakers to the first and second microphones. Additionally, the first and second echo signals would correlate to the output signal, a reference generator would generate a reference signal that linearly correlates to the output signal according to the first and second far end signals, and a multi-channel acoustic echo canceller would filter the reference signal to generate first and second filtered signals to be indicative of the estimated echo signals at the first and second microphones. Meanwhile, the multi-channel acoustic echo canceller would subtract the first filtered signal from the first echo signal to generate a first error signal, and subtract the second filtered signal from the second echo signal to generate a second error signal and then transmits the first and second error signals to the far end apparatus.

### BRIEF DESCRIPTION OF THE DRAWINGS

The invention can be more fully understood by reading the subsequent detailed description and examples with references made to the accompanying drawings, wherein:

FIG. 1 is a block diagram of a conventional near end apparatus in a teleconference system.

FIG. 2 is a block diagram of an exemplary single-channel AEC.

FIG. 3 is a block diagram of an exemplary near end apparatus capable of multi-channel acoustic echo cancellation according to the invention.

FIG. 4 is a block diagram of another exemplary near end apparatus capable of multi-channel acoustic echo cancellation according to the invention.

FIG. 5 is a block diagram of yet another exemplary near end apparatus capable of multi-channel acoustic echo cancellation according to the invention.

FIG. 6 is a block diagram of still another exemplary near end apparatus capable of multi-channel acoustic echo cancellation according to the invention.

FIG. 7 is a flowchart of an exemplary method for multi-channel acoustic echo cancellation.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

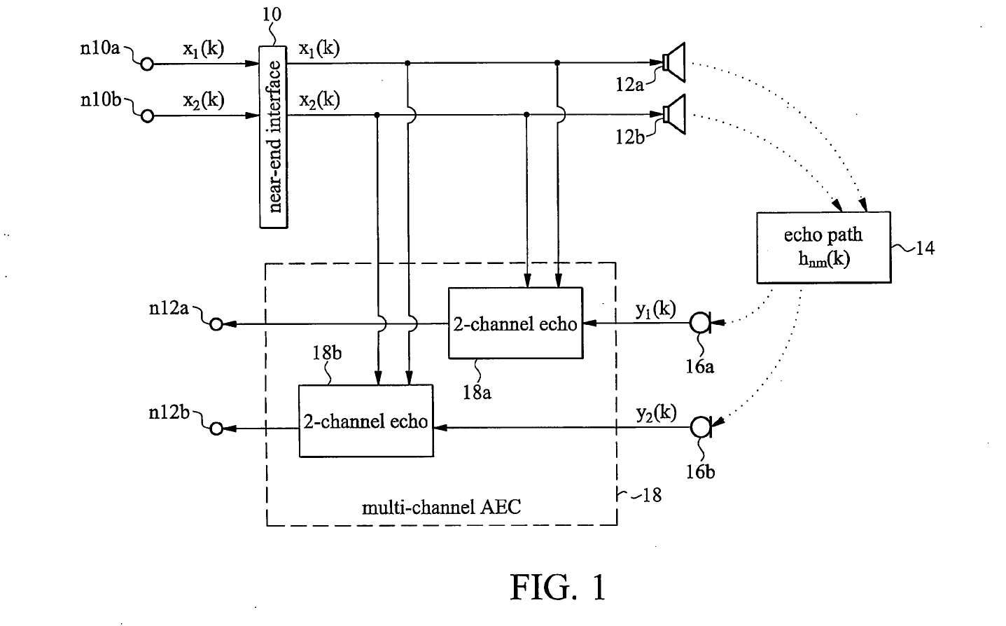

FIG. 1 is a block diagram of a conventional near end apparatus in a teleconference system, comprising a near-end interface 10, speakers 12a and b, echo paths 14, microphones 16a and b, and a multi-channel acoustic echo canceller (AEC) 18. The near end interface 10 is coupled to the speakers 12a and b, the microphones 16a and b are acoustically coupled to the speakers 12a and b through the echo paths 14, and the multi-channel AEC 18 is coupled to the microphones 16a and b.

A TV or desktop teleconference system typically employs multiple channels of speakers and microphones. When the speakers plays far end signals for a plurality of channels, a portion of the played signals are captured by the microphones in conjunction with the speeches made by a user at the near end, i.e., the echo signals of the far end signals are included in the near end signals sent to the far end. As a result, the far end user would hear a delayed echo, which is likely to cause annoyance and is generally undesirable. Thus, an acoustic echo canceller is typically utilized to remove the echo signals by emulating echo estimates and subtracting the echo estimates from the captured signals at the microphones to generate residual signals for transmission to the far end terminal. The multi-channel acoustic system 1 comprises two speakers 12a and b and two microphones 16a and b, thus, also requires two dual-channel AECs 18a and 18b to process the audio signals picked up by the microphones 16a and b. Each audio signal comprises two components broadcasted by the speakers 12a and b through two signal paths. For example, the microphone 16a receives the output signal x₁(k) through an echo path modeled by the h11(k) and the output signal x2(k) through an echo path modeled by the h21(k). For a teleconference system comprising M speakers and N microphones, the multi-channel AEC requires M×N AECs to accurately model the M×N echo paths between the speakers and the microphones, resulting in a complex circuit, increasing design and manufacturing cost, and increasing operation hardware loading.

When applying the conventional near end apparatus to the teleconferencing system including N-channel speakers and M-channel microphone, the echo paths cannot be accurately modeled if the input signals of the microphones have a cross-correlation therebetween. The echo path impulse responses cannot be correctly estimated, thus increasing echo components in the residual signals after removing the echo estimates y′(k) from the captured signal y(k).

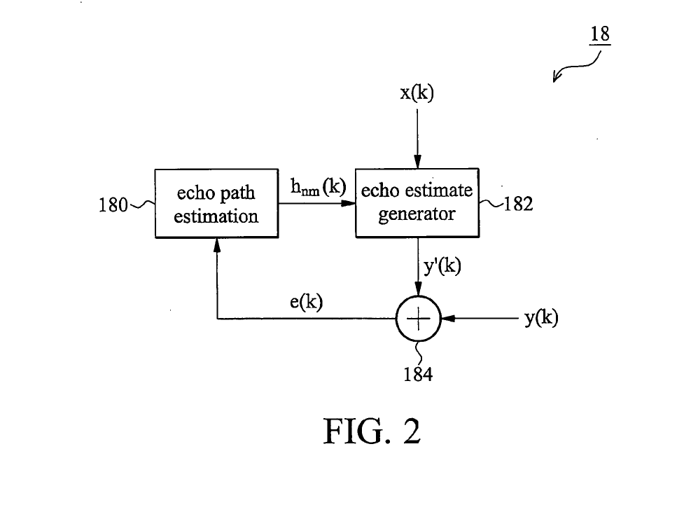

FIG. 2 is a block diagram of an exemplary single-channel AEC, comprising an echo path estimation unit 20, an echo estimate generator 22, and an adder 24, connected in a loop.

The echo path estimation unit 20 receives the error signal e(k) to estimate the weight factors hmn(k) characterizing the echo path such that the error signal e(k) is reduced.

The echo estimate generator 22 may be an adaptive finite impulse response (FIR) filter having sufficient tap length to model the acoustic path. The echo estimate generator 22 receives the weight factors hmn(k) as tap coefficients of the FIR filter to adaptively model the path between the input of a near end speaker and the output of a near end microphone and receives the reference signal S_{ref} to produce the echo estimate y′(k).

The adder 24 subtracts the echo estimate y′(k) from the echo signal y(k) from the microphone to provide the error signal e(k) indicating the remaining echo component in the residual signal to be sent to the far end apparatus.

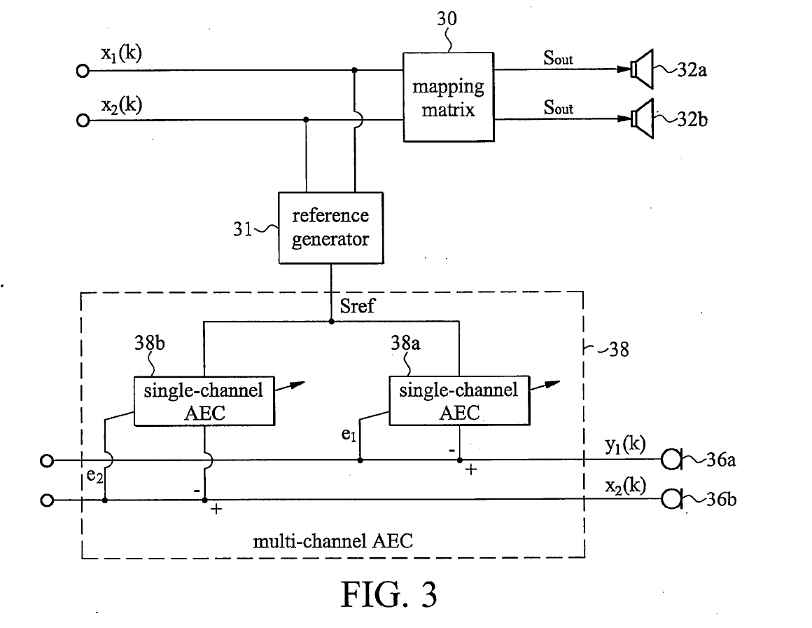

FIG. 3 is a block diagram of an exemplary near end apparatus capable of multi-channel acoustic echo cancellation according to the invention, comprising a mapping matrix 30, a reference generator 31, speakers 32a and b, microphones 36a and b, and a multi-channel AEC 38. The mapping matrix 30 is coupled to the reference generator 31 and the speakers 32a and b, and the microphones 36a and b are acoustically coupled to the speakers 32a and b, and are coupled to the multi-channel AEC 38, which in turn is coupled to the reference generator 31.

The mapping matrix 30 generates the output signals Sₒᵤₜ according to the first and second far end signals x₁(k) and x₂(k). The mapping matrix 30 receives the first and second far end signals x₁(k) and x₂(k) to perform a linear operation thereon to generate the output signal Sₒᵤₜ played by the first and second speakers 32a and b. The first and second far end signals x₁(k) and x₂(k) are analog audio signals that can be converted from digital by a digital-to-analog converter (not shown) in the near end apparatus, or digital audio signals required to be converted to analog prior to being provided to the first and second microphones 36a and b. Since the first and second speakers 32a and b can receive a common output signal Sₒᵤₜ from the mapping matrix 30 and play the common output signal, the correlation issue described in the conventional near end apparatus of the multi-channel AEC no longer exists, thus the multi-channel AEC 38 can accurately estimate echo paths and predict echo estimates y₁′(k) and y₂′(k), so that the residual signals at the output terminals to the far end apparatus can be echo-free or approximately echo-free.

The first and second microphones 36a and b receives the first and second near end signals including the first and second echo signals y₁(k) and y₂(k) that are acoustically coupled from the first and second speakers 32a and b to the first and second microphones 36a and b. The first and second echo signals are correlated to the output signal. The first and second near end signals may be digitized prior to the echo cancellation operation by an analog to digital converter (not shown).

The reference generator 31 generates the reference signal S_{ref} linearly correlated to the output signals Sₒᵤₜ according to the first and second far end signals x₁(k) and x₂(k). The mapping matrix 30 receives the first far end signal x₁(k) and the second far end signal x₂(k) to generate the output signal (a*x₁(k)+b*x₂(k)), and the reference generator 31 receives the first far end signal x1(k) and the second far end signal x2(k) to generate the reference signal (c*x₁(k)+d*x₂(k)). Parameters a, b, c, and d are non-zero constants, for example, parameters a, b, c, and d may all be ½.

The multi-channel AEC 38 comprises AECs 38a and b. The filtering reference signal S_{ref} generates the first and second filtered signals y₁′(k) and y₂′(k) indicative of the estimated echo signals at the first and second microphones. Next, the first filtered signal y1′(k) is subtracted from the first echo signal y₁(k) to generate the first error signal e₁(k), and the second filtered signal y1′(k) is subtracted from the second echo signal y₁(k) to generate a second error signal e₁(k). The first and second error signals are transmitted to a far end terminal (not shown). The AECs 38a and b may be implemented by the AEC block diagram in FIG. 2, wherein each AEC is coupled to only one microphone, comprising an adaptive finite impulse response (FIR) filter, filtering reference signal S_{ref} to generate the first or second filtered signal y₁′(k) and y₂′(k), emulating output signals Sₒᵤₜ propagating through a variety of echo paths to be picked up by microphones 36a and b as echo signals y₁(k) and y₂(k).

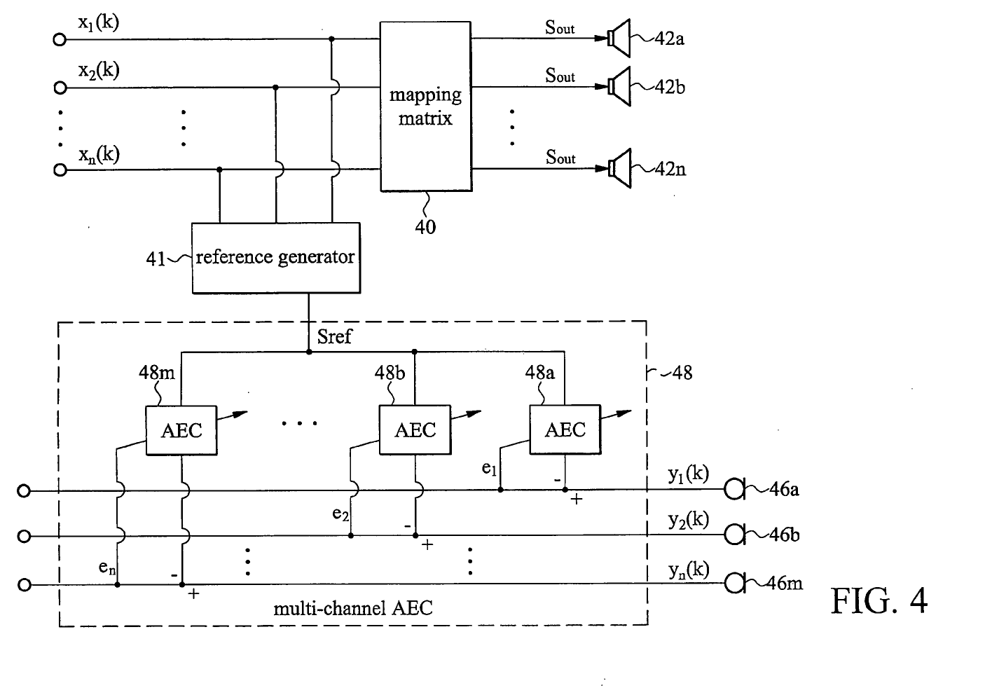

FIG. 4 is a block diagram of another exemplary near end apparatus capable of multi-channel acoustic echo cancellation according to the invention, comprising a mapping matrix 40, a reference generator 41, speakers 42a, b, . . . , m, microphones 46a, b, . . . , n, and a multi-channel AEC 48. The mapping matrix 40 is coupled to the reference generator 41 and the speakers 42a, b, . . . , m, the microphones 46a, b, . . . , n are acoustically coupled to the speakers 42a, b, . . . , m, and are coupled to the multi-channel AEC 48, which in turn is coupled to the reference generator 41.

The near end apparatus in FIG. 4 utilizes multiple speakers and microphones, the operation of the near end apparatus deploys the operation principle disclosed in FIG. 3. The mapping matrix 40 generates the output signals Sₒᵤₜ according to the first and second far end signals x₁(k) and x₂(k) to be played by all speakers. The reference generator 41 generates the reference signal S_{ref} linearly correlated to the output signals Sₒᵤₜ according to the first and second far end signals x₁(k) and x₂(k). Each speaker is coupled to a single-channel AEC as depicted in FIG. 2. The AECs 48a, b, . . . , n comprise FIR filters filtering reference signal S_{ref} to emulate the output signals Sₒᵤₜ traveling through a variety of echo paths before being picked up by each microphone.

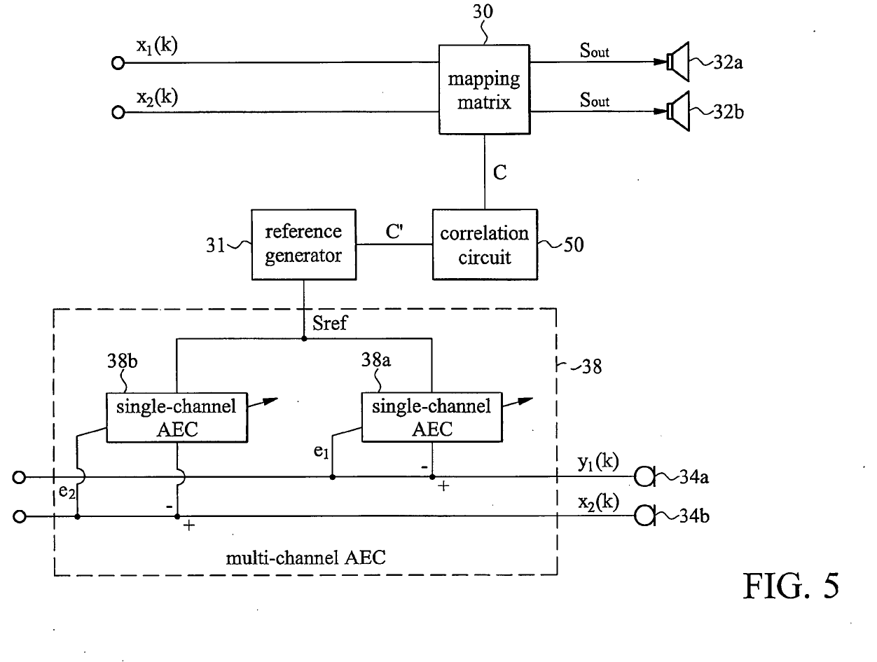

FIG. 5 is a block diagram of yet another exemplary near end apparatus capable of multi-channel acoustic echo cancellation according to the invention, comprising a circuit arrangement similar to the near end apparatus in FIG. 3, except for that a correlation circuit 50 is included between the mapping matrix 30 and the reference generator 31, and the reference generator 31 obtains the far end signal information through the mapping matrix 30 and the correlation circuit 50.

The reference generator 31 is coupled to the mapping matrix 30 through the correlation circuit 50, to receive the output signal Sₒᵤₜ to generate the reference signal S_{ref} so that the output signal Sₒᵤₜ and the reference signal S_{ref} maintain a linear relationship. For example, the correlation circuit 50 may multiply the output signal Sₒᵤₜ by ½ to provide the reference signal S_{ref} for the reference generator 31.

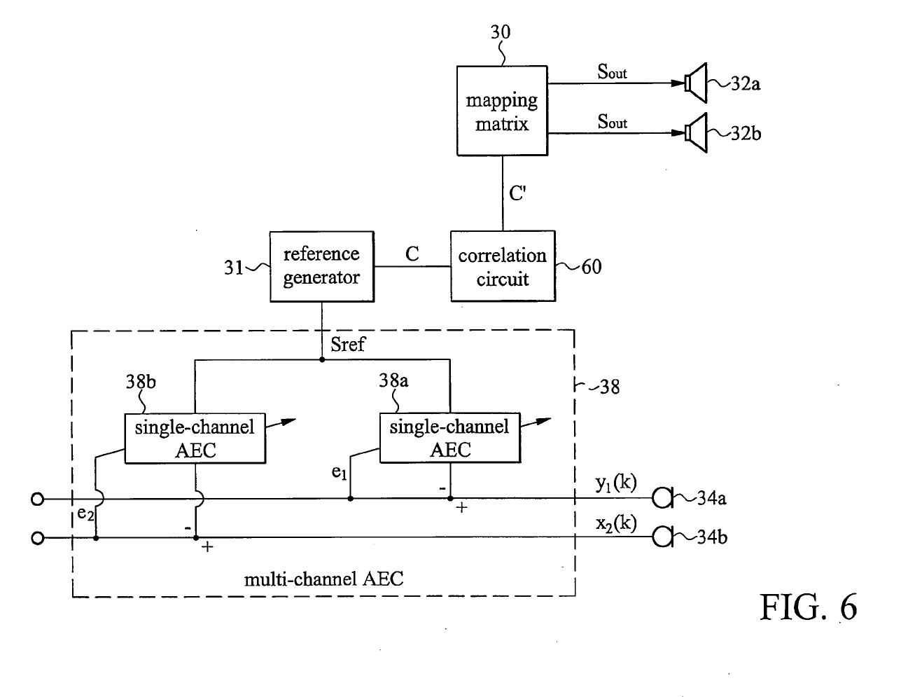

FIG. 6 is a block diagram of still another exemplary near end apparatus capable of multi-channel acoustic echo cancellation according to the invention, comprising a circuit arrangement similar to the near end apparatus in FIG. 3, except for that the correlation circuit 60 is included between the mapping matrix 30 and the reference generator 31, and the mapping matrix 30 obtains the far end signal information through the reference generator 31 and the correlation circuit 60.

The mapping matrix 30 is coupled to the reference generator 31 through the correlation circuit 60, and receives the reference signal S_{ref} to generate the output signal Sₒᵤₜ so that the output signal Sₒᵤₜ and the reference signal S_{ref} maintain a linear relationship. For example, the correlation circuit 60 may multiply the reference signal S_{ref} by 2 to generate the output signal Sₒᵤₜ for the mapping matrix 30.

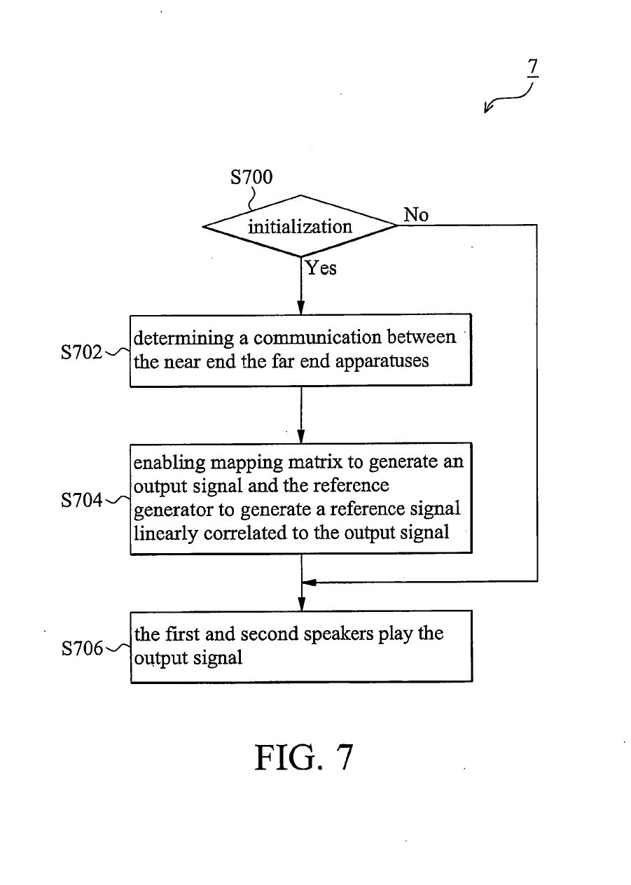

FIG. 7 is a flowchart of an exemplary method for multi-channel acoustic echo cancellation in a duplex communication system, incorporating the near end apparatus in FIG. 3.

Before initialization (step S700) of the acoustic echo cancellation method, the near end apparatus determines whether there is communication between the near end apparatus and the far end apparatus (step S702), if so, the acoustic echo cancellation method continues step S704, and if not, the method goes to step S706. The communication session may be registered in a local register when a user at the near end initiates a teleconference request or accepts a multi-channel communication session from the far end.

In step S704, the mapping matrix 30 is enabled to generate the output signal Sₒᵤₜ according to the first and second far end signals x₁(k) and x₂(k) and the reference generator 31 generates the reference signal S_{ref} linearly correlated to the output signal Sₒᵤₜ according to the first and second far end signals x₁(k) and x₂(k) when there is communication between the near end apparatus and the far end apparatus. The reference signal S_{ref} is subsequently sent to the multi-channel AEC 38 to determine the echo estimates y₁′(k) and y₂′(k) for the echo signals y₁(k) and y₂(k) received at the microphones 36a and b. Since the reference signal S_{ref} is linearly correlated to the output signal Sₒᵤₜ, and the speakers 32a and b play identical the output signal Sₒᵤₜ, the multi-channel AEC requires only one mono-channel AEC for each microphone to compute the corresponding channel estimate. For example, the AEC 38a computes the filtered signal y1′(k) equivalent to Sₒᵤₜ*(h₁₁+h₁₂), or Sₒᵤₜ*hₓ₁, where x indicates the path originating from any source speaker. Further, since the speakers play the identical audio signal, the high cross-correlation therebetween assists in increasing the convergence speed and the prediction accuracy of the computing echo estimates in the AEC, resulting in echo-free or approximately echo-free output audio signals to the remote terminal. The mapping matrix 30 receives the first far end signal x₁(k) and the second far end signal x2(k) to generate the output signal (a*x₁(k)+b*x2(k)), and the reference generator 31 receives the first far end signal x₁(k) and the second far end signal x2(k) to generate the reference signal (c*x₁(k)+d*x2(k)). Parameters a, b, c, and d are non-zero constants, for example, parameters a, b, c, and d may all be ½.

Next in step S706, the first and second speakers 32a and b play the output signal, the first and second microphones 36a and b receive the first and second echo signals y₁(k) and y₂(k) that are acoustically coupled from the first and second speakers 32a and b to the first and second microphones 36a and b, and the multi-channel AEC 38 filters the reference signal S_{ref} to generate the first and second filtered signals y₁′(k) and y₂′(k) to be indicative of the estimated echo signals. Next, the first filtered signal y₁′(k) is subtracted from the first echo signal y₁(k) to generate the first error signal e₁(k), and the second filtered signal y2′(k) is subtracted from the second echo signal y₂(k) to generate the second error signal e₂(k), and then the near end apparatus transmits the first and second error signals e₁(k) and e₂(k) to the far end apparatus. The first and second echo signals are correlated to the output signal Sₒᵤₜ. The method 7 then returns to step S702 to determine the communication status of the near end apparatus. If there is no communication status of the near end apparatus, the method is exited.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus capable of performing acoustic echo cancellation, comprising:
a mapping matrix, generating an output signal according to first and second far end signals;
first and second speakers, coupled to the mapping matrix, playing the output signal;
first and second microphones, receiving the first and second echo signals that are acoustically coupled from the first and second speakers to the first and second microphones, wherein the first and second echo signals are correlated to the output signal;
a reference generator, generating a reference signal linearly correlated to the output signal according to the first and second far end signals; and
a multi-channel acoustic echo canceller, coupled to the reference generator and the first and second microphones, filtering the reference signal to generate the first and second filtered signals to be indicative of the estimated echo signals, subtracting the first filtered signal from the first echo signal to generate a first error signal, and subtracting the second filtered signal from the second echo signal to generate a second error signal, and transmitting the first and second error signals to a far end terminal.

2. The apparatus of claim 1, wherein the mapping matrix receives the first far end signal x1 and the second far end signal x2 to generate the output signal (a* x1+b*x2), and the reference generator receives the first far end signal x1 and the second far end signal x2 to generate the reference signal (c*x1+d*x2), and parameters a, b, c, and d are non-zero constants.

3. The apparatus of claim 1, wherein the parameters a, b, c, and d are ½.

4. The apparatus of claim 1, wherein the reference generator is coupled to the mapping matrix, receiving the output signal to generate the reference signal.

5. The apparatus of claim 1, wherein the mapping matrix is coupled to the reference generator, receiving the reference signal to generate the output signal.

6. The apparatus of claim 1, wherein the multi-channel acoustic echo canceller comprises two acoustic echo cancellers (AEC), and each are coupled to only one microphone, comprising an adaptive finite impulse response (FIR) filter which filters the reference signal to generate the first or second filtered signal.

7. A method of a signal processing at a near end apparatus of a duplex communication system for acoustic echo cancellation, comprising:
determining whether there is communication between the near end apparatus and a far end apparatus;
a mapping matrix generating an output signal according to the first and second far end signals when there is communication;
first and second speakers playing the output signal;
first and second microphones receiving the first and second echo signals that are acoustically coupled from the first and second speakers to the first and second microphones, wherein the first and second echo signals are correlated to the output signal;
a reference generator generating a reference signal linearly correlated to the output signal according to the first and second far end signals when there is communication;
a multi-channel acoustic echo canceller filtering the reference signal to generate the first and second filtered signals to be indicative of the estimated echo signals;
the multi-channel acoustic echo canceller subtracting the first filtered signal from the first echo signal to generate a first error signal, and subtracting the second filtered signal from the second echo signal to generate a second error signal; and
transmitting the first and second error signals to the far end apparatus.

8. The method of claim 7, wherein the generation of the output signal comprises the mapping matrix receiving the first far end signal x1 and the second far end signal x2 to generate the output signal (a*x1+b*x2), and the generation of the reference signal comprises the reference generator receiving the first far end signal x1 and the second far end signal x2 to generate the reference signal (c*x1+d*x2), wherein parameters a, b, c, and d are non-zero constants.

9. The method of claim 7, wherein the parameters a, b, c, and d are ½.

10. The method of claim 7, wherein the generation of the reference signal, comprise the reference generator receiving the output signal to generate the reference signal.

11. The method of claim 7, wherein the generation of the output signal, comprise the mapping matrix receiving the reference signal to generate the output signal.

12. The method of claim 7, wherein the multi-channel acoustic echo canceller comprises two acoustic echo cancellers (AEC), and each are coupled to only one microphone, comprising an adaptive finite impulse response (FIR) filter, wherein the reference signal is filtered to generate the first or second filtered signal.
